(19) United States
(12) Patent Application Publication
(10) Pub. No.: US 2007/0034290 A1
(43) Pub. Date: Feb. 15, 2007

(54) Grinding machine rotor assembly and clamp apparatus therefor

(76) Inventor: Robert Joseph Wenzlick III, Weidman, MI (US)

Correspondence Address: REISING, ETHINGTON, BARNES, KISSELLE, P.C., P O BOX 4390, TROY, MI, 48099-4390, US

(21) Appl. No.: 11/481,436

(22) Filed: Jul. 6, 2006

Related U.S. Application Data
(60) Provisional application No. 60/696,836, filed on Jul. 6, 2005.

(51) Int. Cl. B27G 13/00; B27C 1/00; B27C 5/00

(52) U.S. Cl. 144/218

(57) ABSTRACT

A clamp apparatus for retaining coaxial components on a shaft of a wood fragmenting rotor assembly includes two interconnectable clamp segments having respective recesses that define a receptacle for receiving a rotor assembly shaft when the clamp segments are interconnected and moved toward one another. Clamp camming surfaces extend radially inwardly from at least a portion of each of the respective recesses and engage a shaft camming surface of a rotor assembly shaft as the clamp segments are moved toward one another about the shaft. A closure moves the clamp segments toward each other, bringing the clamp camming surfaces into engagement with shaft camming surface of the rotor assembly and producing a camming action between the clamp camming surfaces and the shaft camming surface that drives the clamp segments axially inward along the shaft, which drives the coaxial rotor assembly components into desired respective axial abutting positions along the shaft.

### CROSS REFERENCE TO RELATED APPLICATION

This application incorporates by reference and claims priority in U.S. provisional patent application Ser. No. 60/696,836, filed 6 Jul. 2005.

### BACKGROUND OF THE INVENTION

1. Field of the Invention

This invention relates generally to rotor assemblies for heavy machinery such as those with hammer mills for fragmenting waste wood including stumps, pallets, large timbers, and the like into particulate or chips, and more particularly to a clamp apparatus for maintaining cutter-mounting rotor plates in an axially fixed position along a shaft of a rotor assembly.

2. Related Art

Heavy machinery used for fragmenting waste wood product, such as horizontal grinders and tub grinders, typically have a hammer mill including a driven shaft with rotor plates coaxially spaced from one another along the shaft by spacer plates. The rotors generally carry support or hammer bodies for co-rotation with the driven shaft, with cutter inserts arranged to extend radially outwardly from the hammer bodies for fragmenting engagement with the waste wood product.

The driven shaft typically has threaded portions adjacent its opposite ends for threaded engagement with lock nuts. The lock nuts are typically tightened on the threaded portions for axial engagement with end plates. The end plates are moved axially toward each other into axial compression with the rotor plates in response to tightening of the nuts, thereby causing the rotor plates and spacer plates to be axially compressed into a generally fixed position along the driven shaft. Though lock nuts prove useful in retaining the respective components in their axially fixed position along the driven shaft, ever heavier machinery requires different and improved solutions to problems that may be encountered.

### INVENTION SUMMARY

A clamp apparatus is provided for retaining coaxial components on a shaft of a wood fragmenting rotor assembly of a type in which the shaft is driven in rotation by a motor and carries cutters for conjoint rotation with the shaft and for fragmenting engagement with waste wood product. The clamp apparatus comprises two interconnectable clamp segments having respective recesses configured to define a receptacle for receiving a rotor assembly shaft when the clamp segments are interconnected. Clamp camming surfaces extend radially inwardly from at least a portion of each of the respective recesses and are configured to engage corresponding shaft camming surfaces of a rotor assembly shaft as the clamp segments are moved toward one another about the shaft. A closure mechanism is adjustable to move the clamp segments toward each other around a rotor assembly shaft, bringing the clamp camming surfaces into engagement with shaft camming surfaces of the rotor assembly and producing a camming action between the clamp and shaft camming surfaces that drives the clamp segments axially inward along the shaft. Axially inward movement of the camming surfaces drives coaxial components of a wood fragmenting rotor assembly into desired respective axial abutting positions along the shaft. The novel clamp apparatus, among other things, improves manufacturing efficiencies, improves serviceability, and extends the useful life of a rotor assembly.

According to another aspect of the invention a method is provided for assembling a rotor assembly for a wood fragmenting machine. The method includes the steps of forming a shaft camming surface on a shaft of the rotor assembly, providing a stop on the shaft spaced from the shaft camming surface, providing a plurality of coaxial rotor assembly components on the shaft between the shaft camming surface and the stop, and providing a clamp apparatus on the shaft adjacent the shaft camming surface. The clamp apparatus comprises two interconnected clamp segments having respective recesses defining a receptacle for receiving the shaft, clamp camming surfaces extending radially inwardly from at least a portion of each of the respective recesses for engaging the respective shaft camming surfaces, and a closure adjustable to move the clamp segments toward each other around the shaft. The coaxial rotor assembly components are driven into desired respective axial abutting positions along the shaft and against the first stop by adjusting the closure to produce a camming action between the clamp and shaft camming surfaces that drives the clamp segments axially inward along the shaft.

### BRIEF DESCRIPTION OF THE DRAWINGS

Some of the objects, features and advantages of the invention will become readily apparent in view of the following detailed description of the presently preferred embodiments and best mode, appended claims, and accompanying drawings, in which:

FIG. 1 is a schematic plan view of a partially assembled rotor assembly;

FIG. 2 is an orthogonal view showing a first embodiment of a clamp apparatus maintaining rotor plates on a shaft of the rotor assembly of FIG. 1;

FIG. 3 is a partial exploded plan view of the rotor assembly of FIG. 1;

FIG. 4 is an end view of the shaft of the rotor assembly of FIG. 1;

FIG. 5 is a partial cross sectional view of the clamp apparatus and an end plate assembly of the rotor assembly of FIG. 1;

FIG. 6 is a perspective view of a second embodiment of a clamp apparatus for maintaining rotor plates on a shaft of a rotor assembly;

FIG. 7 is a plan view of the clamp apparatus of FIG. 6;

FIG. 8 is a cross sectional view taken generally along line 8-8 of FIG. 7;

FIG. 9 is a perspective view of a third embodiment of a clamp apparatus for maintaining rotor plates on a shaft of a rotor assembly;

FIG. 10 is an end view of the clamp apparatus of FIG. 9;

FIG. 11 is a plan view of the clamp apparatus of FIG. 9; and

FIG. 12 is a cross-sectional top view of the clamp apparatus of FIG. 9 taken along line 12-12 of FIG. 10.

### DETAILED DESCRIPTION OF THE PREFERRED EMBODIMENTS

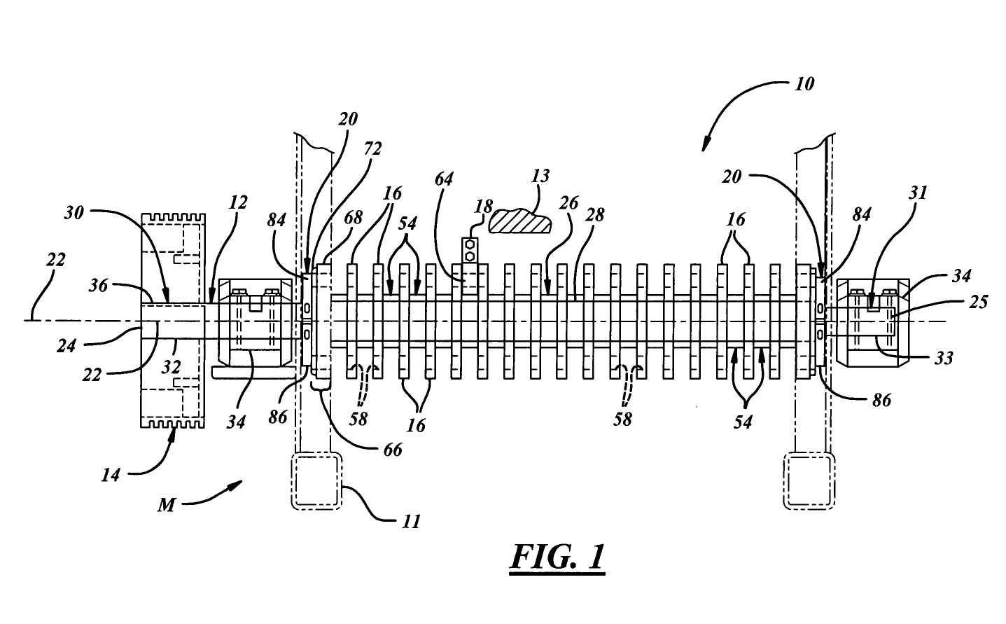

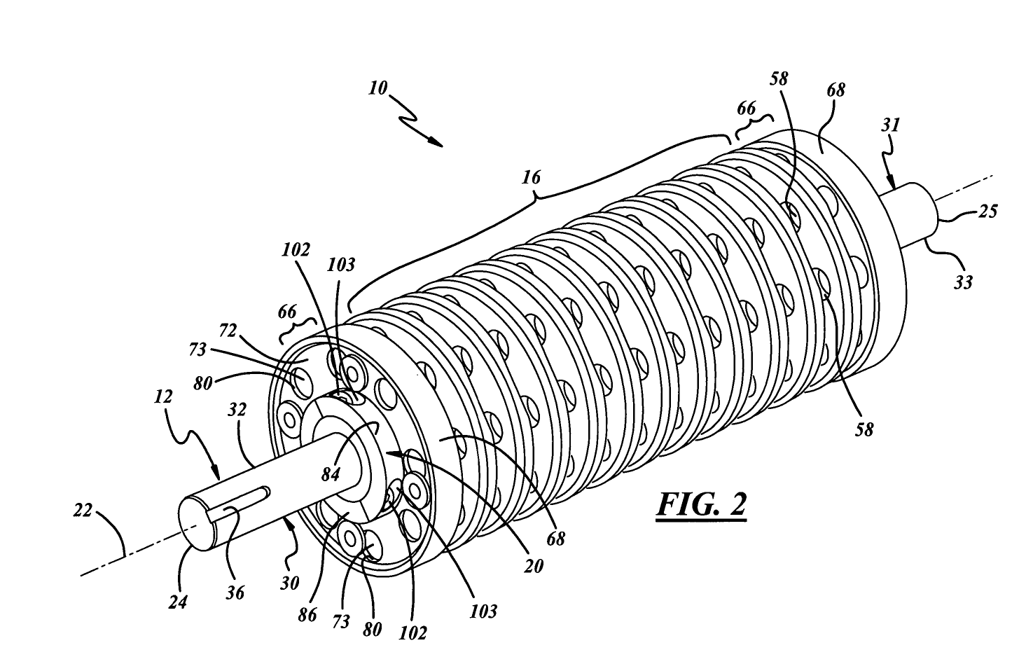

FIGS. 1 and 2 illustrate a partially assembled rotor assembly 10 for use in a grinding or wood fragmenting machine M, such as disclosed in U.S. Pat. No. 6,880,774 to Bardos et al. (the Bardos patent), assigned to the present applicant Morbark, Inc., and incorporated herein by reference in its entirety. A frame 11 of the machine M carries an anvil surface 13 to facilitate grinding or fragmenting waste wood product. The rotor assembly 10 has a shaft 12 arranged for operable attachment to a drive mechanism, such as a sprocket or sheave 14 in operable communication with a motor. The rotor assembly 10 may be incorporated in either a horizontal grinder or a tub grinder, as disclosed in the Bardos patent.

The rotor assembly 10 includes a plurality of coaxial components such as rotor plates 16 that are received coaxially on the shaft 12. A plurality of cutters or cutter inserts 18 are carried by and extend radially outwardly from the rotor plates 16. The cutter inserts 16 are arranged to be cooperable with the anvil surface 13 to provide fragmenting engagement of the inserts 18 and anvil surface 13 with waste wood product. Rather than using a nut as an axial stop to locate and secure the rotor plates 16 on the shaft 12 as disclosed in the referenced Bardos patent, the rotor assembly 10 includes at least one clamp apparatus 20 for use an adjustable axial stop, fixing the rotor plates 16 relative to the shaft 12 for co-rotation with the shaft 12. Two such clamp apparatti 20 may be used as stops at respective opposite ends of the rotor assembly 10 as shown in FIG. 1, or a single clamp apparatus 20 may be used at only one end of the assembly 10. Where only a single clamp apparatus 20 is used, the rotor plates 16 may be axially retained at the other end of the assembly 10 by any suitable form of stop known in the art.

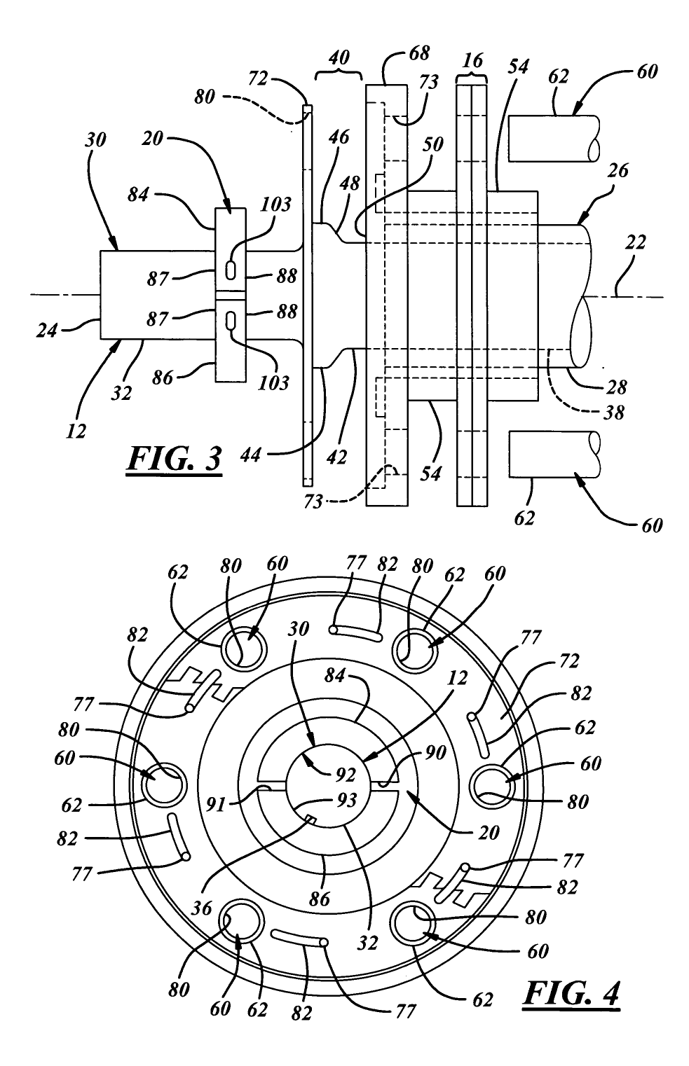

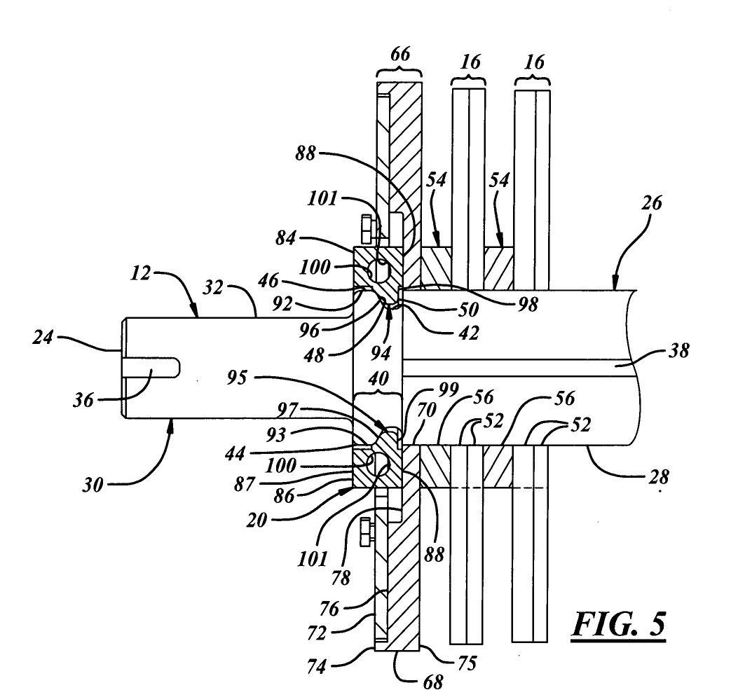

The shaft 12 extends along an axis 22 between opposite ends 24, 25 and, as shown in FIG. 1, may include a midsection 26 having an outer surface 28 and end portions 30, 31 having respective outer surfaces 32, 33. The outer surfaces 32, 33 are concentric with the midsection outer surface 28 but may have diameters less than that of the midsection 26. The end portions 30, 31 may be arranged for journaled support in bearings 34 mounted on the frame 11 of the machine M. A driven end portion 30 of the two end portions 30, 31 of the shaft 12 may include a keyway 36 that extends axially along the shaft 12 to facilitate operably attaching and transmitting torque from the sheave 14 to the shaft 12. As shown in FIGS. 3 and 5, the midsection 26 may include a keyway 38 extending axially along the shaft 12 to facilitate orienting the rotor plates 16 on the shaft 12, and to prevent rotation of the rotor plates 16 relative to the shaft 12.

As shown in FIGS. 3 and 5, the shaft 12 has a clamp portion 40 adjacent at least one end 24 of the shaft 12. Alternatively, clamp portions 40 may be included adjacent both ends 24, 25 of the shaft 12. Each clamp portion 40 may be formed generally between the midsection 26 and one of the end portions 30, 31 of the shaft 12. Each clamp portion 40 of the shaft 12 may be defined in part by a neck or groove 42 extending circumferentially about the shaft 12 and radially inwardly from the outer surface 28 of the midsection 26 to define a circumferentially extending flange 44 between the groove 42 and the end portion 30, 31. Each flange 44 may have a circumferentially outer surface 46 of equal or slightly less diameter than the outer surface 28 of the midsection 26. The circumferential groove 42 of each clamp portion 40 of the shaft 12 provides at least one shaft camming surface 48 on the flange 44 of each clamp portion 40 of the shaft 12. The shaft camming surface 48 of each clamp portion 40 may extend to a shoulder 50 of the shaft 12 defined adjacent the midsection 26. The shaft camming surface 48 may be inclined obliquely between about 45-75 degrees to the axis 22 and may converge axially away from the adjacent end 24, 25 of the shaft 12 and radially inward toward the shaft axis 22. The circumferential groove 42 of each clamp portion 40 has a width defined between the shoulder 50 and the shaft camming surface 48, and thus, the width of the groove 42 increases in a radially outward direction from the axis 22.

As shown in FIG. 5, each of the rotor plates 16 has a bore 52 sized for close receipt on the midsection 26 of the shaft 12. The rotor plates 16 are preferably spaced axially from one another by other rotor plates functioning as spacers 54, the spacers 54 having bores 56 sized for close receipt on the midsection 26 of the shaft 12. Each of the rotor plates 16 and each of the spacers 54 may have a radially inwardly extending key (not shown) sized for close receipt in the shaft keyway 38 to prevent rotation of the rotor plates 16 and spacers 54 relative to the shaft 12. Each of the rotor plates 16 may have circumferentially spaced, axially-directed, through-openings 58 as shown in FIGS. 1 and 2. The through-openings 58 may be spaced radially outward from the bore 52, arranged for axial alignment with one another, and sized for the close receipt of hammer support rods 60 as shown in FIGS. 3 and 4. The spacers 54 may, in some installations, also be adapted for operable attachment to hammer or cutter support members.

The hammer support rods 60, upon being disposed in the axially aligned through-openings 58 in the rotor plates 16, extend generally parallel to the shaft axis 22. Each of the hammer support rods 60 may have an outer surface 62 sized for close receipt through-openings in a plurality of cutter support bodies or hammer bodies 64 as shown in FIG. 1. The hammer bodies 64 may, in turn, be adapted for the cutter inserts 18 to be attached to them, such that the cutter inserts 18 extend radially outwardly from the hammer bodies 64 as disclosed in the Bardos patent. The mechanisms used for carrying the cutter inserts 18 for rotation about the shaft axis 22 can vary, as suggested in the referenced Bardos patent, with those mechanisms being incorporated by reference into this document.

The rotor assembly 10 may include a pair of rod locking end plate assemblies 66 as shown in FIG. 5. Each end plate assembly 66 may include an end plate 68 having an axial bore 70 for close receipt on the midsection 26 of the shaft 12. Each end plate assembly 66 may also include a locking plate 72 for cooperation with the end plate 68. The end plate 68 of each end plate assembly 66 has generally parallel faces 74, 75, with one face 74 being oriented in an axially outwardly direction and the other face 75 being oriented axially inwardly for engagement with an adjacent spacer 54. The end plate 68 of each end plate assembly 66 may also have through-openings 73 as shown in FIG. 3. The end plate through-openings 73 may be arranged for axial alignment with the through-openings 58 in the rotor plates 16 and sized for close receipt of the rods 60. An outer recess 76 may extend into the axially outward face 74 of each end plate 68 for receipt of the locking plates 72. An inner counterbore 78 may also extend into each end plate 68 for receipt of the clamp apparatus 20.

As best shown in FIG. 4, the locking plate 72 of each end plate assembly 66 may include through-openings 80. These locking plate through-openings 80 of each locking plate 72 may be arranged for axial alignment with the end plate through-openings 73 of each end plate 68 by rotating each locking plate 72 relative to its respective associated end plate 68 into an unlocked position. The locking plate through-openings 80 of a locking plate 72 may also be misaligned with the end plate through-openings 73 of an associated end plate 68 by rotating the locking plate 72 relative to the end plate 68 to a locked position, as is disclosed in the Bardos patent. Relative rotational movement of the locking plates 72 may be restricted to motion between the locked and the unlocked positions by bolts 77 extending from the end plates 68 and received in arcuate slots 82 in the locking plates 72, as is also disclosed in the Bardos patent. When both locking plates are in their respective locked positions with their through-openings 80 misaligned relative to the end plate through-openings 73 of their respective associated end plates 68, the rods 60 are locked in their operating positions against axial motion.

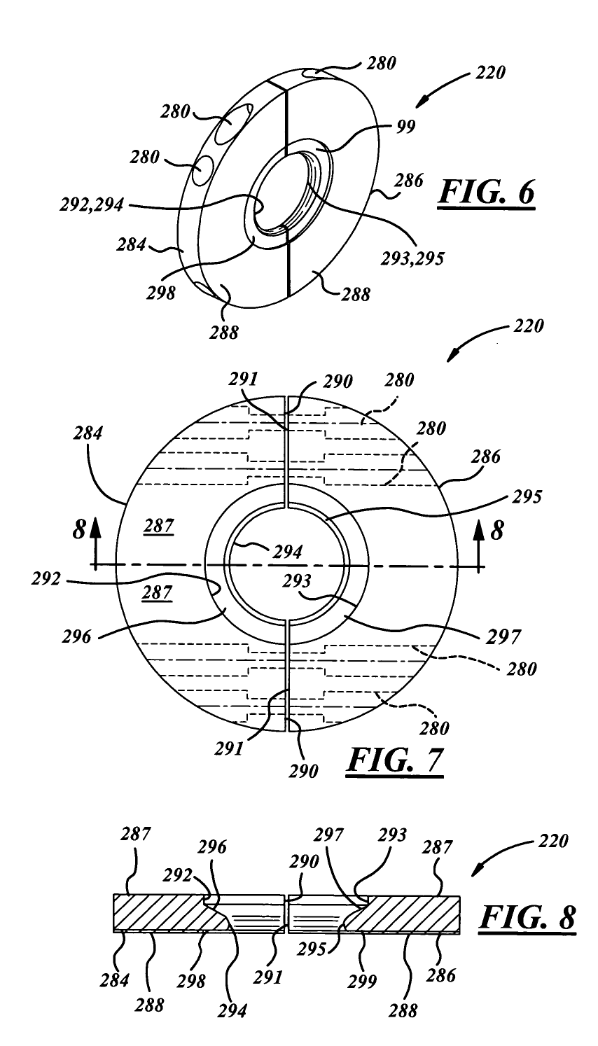

The clamp apparatus 20 may include two interconnectable clamp segments 84, 86 which, as best shown in FIGS. 6 and 7, may be generally semicircular or half-circular, generally flat steel plates (by way of example and without limitations). Each of the clamp segments 84, 86 may have generally parallel opposite axial end surfaces 87, 88. As shown in FIGS. 4 and 7, each of the clamp segments 84, 86 may also have a pair of interface surfaces 90, 91. When the clamp segments 84, 86 are joined together as shown in the drawings, the pairs of interface surfaces 90, 91 are disposed opposite and in a generally coplanar and abutting relationship with each other. Generally semi cylindrical or half-cylindrical recesses 92, 93 extend between the interface surfaces of each interface surface pair 90, 91, defining a receptacle for receiving a rotor assembly shaft 12 and giving the interconnected clamp segments 84, 86 a generally annular shape. As best shown in FIG. 5, the clamp segments 84, 86 include diametrically-opposite arcuate protrusions 94, 95 that extend radially inwardly toward one another from the respective semi cylindrical recesses 92, 93. The arcuate protrusions 94, 95 have respective circumferentially extending inclined clamp camming surfaces 96, 97 that also extend radially inwardly from at least a portion of each of the respective recesses 92, 93. The clamp camming surfaces 96, 97 are each generally half-frustoconical and are inclined relative to the shaft axis 22 at generally the same angle of inclination and in the same direction as the shaft camming surface 48. This configuration provides shoulders 98, 99 on an opposite side of the arcuate protrusions 94, 95 of each plate segment 84, 86. The shoulders 98, 99 extend generally parallel to the axial end surfaces 87, 88 of the clamp segments 84, 86 and are preferably recessed slightly from the adjacent end surfaces 87, 88. Widths of the arcuate protrusions 94, 95, defined between the respective shoulders 98, 99 and clamp camming surfaces 96, 97, increase in a radially outward direction from the axis 22 and are at least slightly less than the width of the corresponding shaft groove 42.

The clamp apparatus 20 also includes a closure mechanism that is adjustable to move the clamp segments 84, 86 toward each other edgewise around the rotor assembly shaft 12, bringing the clamp camming surfaces 96, 97 into engagement with the shaft camming surface 48 of the rotor assembly 10 and producing a camming action between the shaft and clamp camming surfaces 48, 96, 97 that axially drives the clamp segments 84, 86 axially inward along the shaft 12, which drives the coaxial components, e.g., the rotor plates 16 and spacers 54 of the rotor assembly 10 into desired respective axial abutting positions along the shaft 12. As shown in FIG. 5, the closure mechanism may include through-openings 100 in the clamp segments 84, 86 that extend between the end surfaces 87, 88 of the clamp segments 84, 86 and generally perpendicularly through a separate one of the opposite interface surfaces 90. The through-openings 100 in one plate segment 84 may be arranged for axial alignment with through-openings 100 in the other plate segment 86 when the clamp segments 84, 86 are arranged in generally mirrored relation to one another. The through-openings 100 may have a reduced diameter portion 101 sized for closed receipt of an adjustable mechanism or fastener, such as a machine bolt 102, for example, and an enlarged counterbore 103 for receipt of an enlarged head of the bolt 102 and corresponding nut as shown in FIG. 2.

In assembly, a shaft camming surface 48 is formed on the rotor assembly shaft 12 adjacent one or both end portions 30, 31 of the shaft 12 by forming the or each circumferential groove 42 and flange 44 between the midsection 26 and an end portion 30, 31 of the shaft 12. The other coaxial rotor assembly components, such as rotor plates 16 and corresponding spacers 54, are alternatingly disposed on the shaft midsection 26 and the end plates 68 are disposed on the shaft midsection 26, as shown in FIG. 5, to abut the adjacent spacers 54. The rotor plates 16 and spacers 54 have predetermined thicknesses to leave room for the end plates 68 to be disposed on the midsection 26 of the shaft 12. When the end plates 68 are disposed on the shaft 12, the counterbores 78 are generally flush with or slightly recessed axially inwardly from the shoulders 50 on the shaft 12.

The or each clamp segment 84, 86 of the clamp apparatus 10 is then disposed about the circumferential groove 42 such that the clamp camming surfaces 96, 97 of the clamp apparatus clamp segments 84, 86 are brought into abutment with the shaft camming surface 48. Where only one clamp apparatus 10 is used adjacent one end portion 31 of the shaft 12, a stop is supported adjacent the opposite end portion 32 of the shaft 12. The or each closure mechanism is then adjusted to move the clamp segments toward each other around the shaft 12. More specifically, with the through-openings 100 of the closure mechanism in the opposite clamp segments 84, 86 aligned with one another, the closure fasteners 102 are inserted into the openings 100 and may be tightened to a predetermined torque specification that may depend on the size of the bolts 102 and rotor assembly 10. As the fasteners 102 are tightened, preferably in generally uniform fashion, the clamp camming surfaces 96, 97 of the clamp segments 84, 86 move radially inwardly for camming engagement along the shaft camming surfaces 48 which causes the sides 88 of the clamp segments 84, 86 to be cammed axially toward and into abutment with the end plate 68. Upon reaching the predetermined torque specification, the inward axial movement of the clamp segments 84, 86 causes the adjacent end plate 68 to move axially which causes the rotor plates 16 and spacers 54 to be brought into at least partial compression with one another. In other words, the coaxial rotor assembly components 16, 54 are driven into desired respective axial abutting positions along the shaft 12 by adjusting the closure mechanism to produce a camming action between the clamp camming surfaces 96, 97 and the shaft camming surface 48 that drives the clamp segments 84, 86 axially inward along the shaft 12. Accordingly, any axial play is removed from between the rotor plates 16, spacers 54, and end plates 68. Further, upon reaching the predetermined torque specification, the protrusions 94, 95 on the clamp segments 84, 86 are in clearance from the respective groove 42 in the shaft 12, with the exception of the mating clamp camming surfaces 96, 97 and the shaft camming surfaces 48, and the opposed interface surfaces 90 of the clamp segments 84, 86 have at least a slight gap between them. As such, when the torque tolerance is reached, the rotor assembly 10 is assured of having the proper compression between the abutting components.

Upon assembling the clamp apparatus 20 on the shaft 12, the hammer bodies 64 with the corresponding cutter inserts 18 attached to them are arranged in position so that when the hammer support rods 60 are inserted through the aligned through-openings 58 in the rotor plates 16, the rods 60 also pass through the hammer bodies 64. Thereafter, the locking plate 72 can be disposed over the clamp apparatus 20 and attached to the end plate 68 to lock the hammer support rods 60 in place. The locking plate 72 may be supported by the end plate 68 in advance, such that the locking plate 72 only need to be rotated through an arc defined by the slots 82 to close off the through-openings 73 in the end plate 68 and block axial movement of the rods 60.

In FIGS. 6-8, a second embodiment of a clamp apparatus 220 is shown. According to this embodiment, instead of using a pair of fasteners 102 in a corresponding pair of through-openings 73 to join the plates 284, 286 to one another, four through-openings 280 are provided to receive four fasteners (not shown). Otherwise, the clamp apparatus 220 is generally the same as the first clamp apparatus embodiment 20 described above.

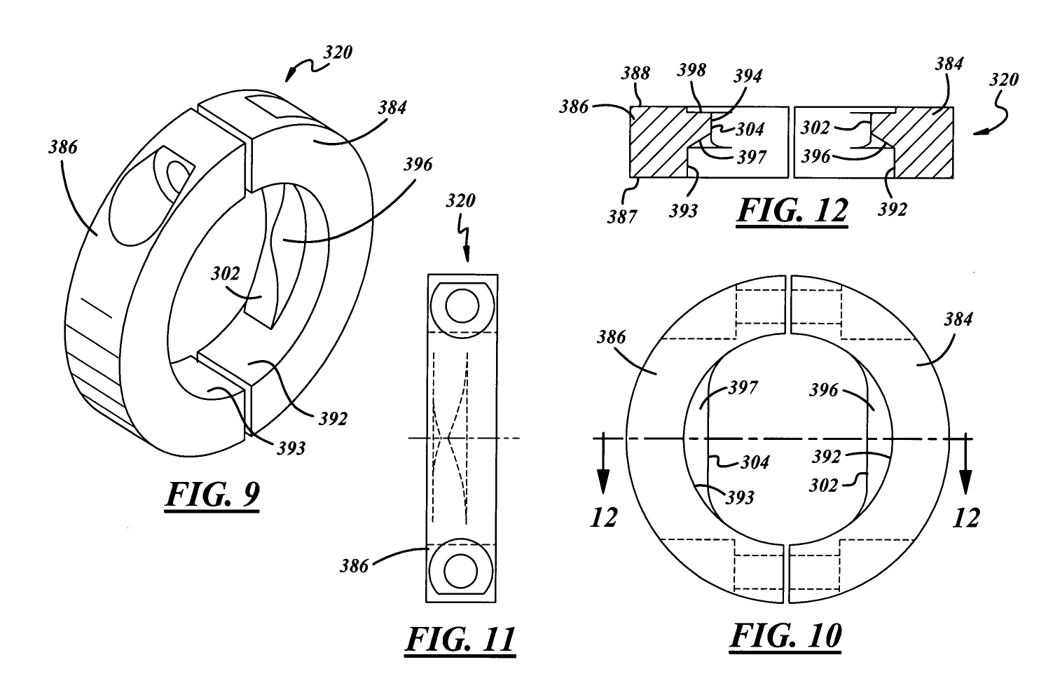

In FIGS. 9-12 a third embodiment of a clamp apparatus 320 is shown. According to this embodiment the clamp camming surfaces 396, 397 are semi-frustoconical in shape rather than half-frustoconical and have inner facing edges 302, 304 that are generally parallel to and spaced from each other and extend generally chordwise across their respective recesses 392, 393. Opposite ends of the inner facing edges 302, 304 of the clamp camming surfaces 396, 397 are blended into the recesses as best shown in FIG. 10. This blended semi-frustoconical shape eliminates corners that would otherwise exist at either end of a half-frustoconical protrusion as shown in FIG. 7 with respect to the second clamp apparatus embodiment 220. Such corners tend to dig into a corresponding shaft camming surface outside a narrow range of relative axial positions where matching radii of the respective camming surfaces are generally aligned. Otherwise, the clamp apparatus 320 is generally the same as the first clamp apparatus embodiment 20 described above.

Upon reading this disclosure, one of ordinary skill in the art will readily recognize embodiments other than those disclosed. For example, rather than using a machine bolt and nut to attach the opposite clamp segments 84, 86 to one another, one of the plates could have threaded openings, thus doing away with the necessity for nuts. Alternatively, the adjustable closure mechanism could include other types of fasteners, such as ratcheting bands, or the like. Further, the number of fasteners used to join the clamp segments to one another could be varied, depending on the size of the clamp apparatus and the application. In addition, the groove could be provided in the clamp segments and the protrusion provided on the shaft. Accordingly, this disclosure is intended to be exemplary, and not limiting. The following claims define the scope of the invention as will any additional claims that may subsequently be filed.

What is claimed is:

1. A clamp apparatus for retaining coaxial components on a shaft of a wood fragmenting rotor assembly of a type in which the shaft is driven in rotation by a motor and carries cutters for conjoint rotation with the shaft and for fragmenting engagement with waste wood product; the clamp apparatus comprising:
two interconnectable clamp segments having respective recesses configured to define a receptacle for receiving a rotor assembly shaft when the clamp segments are interconnected;
clamp camming surfaces extending radially inwardly from at least a portion of each of the respective recesses and configured to engage a corresponding shaft camming surface of a rotor assembly shaft as the clamp segments are moved toward one another about the shaft; and
a closure mechanism adjustable to move the clamp segments toward each other around a rotor assembly shaft, bringing the clamp camming surfaces into engagement with a shaft camming surface of the rotor assembly and producing a camming action between the clamp camming surfaces and the shaft camming surface that drives the clamp segments axially inward along the shaft, which drives coaxial components of a wood fragmenting rotor assembly into desired respective axial abutting positions along the shaft.

2. The clamp apparatus of claim 1 in which the clamp camming surfaces are configured to engage a shaft camming surface that is disposed on a frusto-conical surface inclined to and concentrically disposed about a rotational axis of the shaft.

3. The clamp apparatus of claim 1 in which:
protrusions extend radially inwardly toward one another from the respective recesses; and
the clamp camming surfaces are disposed on the protrusions.

4. The clamp apparatus of claim 3 in which the clamp camming surfaces are each generally half-frustoconical in shape.

5. The clamp apparatus of claim 3 in which the clamp camming surfaces are semi-frustoconical in shape and have inner facing edges that are generally parallel to and spaced from each other.

6. The clamp apparatus of claim 5 in which the inner facing edges of the clamp camming surface extend generally chordwise across their respective recesses.

7. The clamp apparatus of claim 6 in which opposite ends of the inner facing edges are blended into the recesses.

8. The clamp apparatus of claim 1 in which the closure comprises through-openings in the clamp segments and a pair of fasteners received in the through-openings.

9. A rotor assembly for a wood fragmenting machine, comprising:
a shaft;
a shaft camming surface disposed on the shaft;
a first stop disposed on the shaft and spaced from the shaft camming surface;
a plurality of coaxial components received on the shaft between the shaft camming surface and the first stop;
a second stop in the form of a clamp apparatus carried by the shaft adjacent the shaft camming surface and comprising:
two interconnected clamp segments having respective recesses defining a receptacle receiving the shaft;
clamp camming surfaces extending radially inwardly from at least a portion of each of the respective recesses and engaging the shaft camming surface; and
a closure adjustable to move the clamp segments toward each other around the shaft, bringing the clamp camming surfaces into engagement with shaft camming surface and producing a camming action between the clamp cammning surfaces and the shaft camming surface that drives the clamp segments axially inward along the shaft, which drives the coaxial components into desired respective axially abutting positions along the shaft and against the first stop.

10. The clamp apparatus of claim 9 in which the coaxial components include:
rotor plates;
hammer bodies attached to the rotor plates; and
cutter inserts carried by and extending radially outward from the hammer bodies.

11. The rotor assembly of claim 9 in which:
the shaft camming surface converges axially toward the second stop and radially inward toward a shaft rotational axis; and
the clamp camming surfaces converge axially toward the second stop and radially inward toward the shaft rotational axis.

12. The clamp apparatus of claim 11 in which the shaft camming surfaces are disposed on a frusto-conical surface inclined to and concentrically disposed about a rotational axis of the shaft.

13. The clamp apparatus of claim 12 in which the frusto-conical surface is defined by a circumferential groove formed around the shaft.

14. A method for assembling a rotor assembly for a wood fragmenting machine; the method including the steps of:
forming a shaft camming surface on a shaft of the rotor assembly;
providing a stop on the shaft spaced from the shaft camming surface;
providing a plurality of coaxial rotor assembly components on the shaft between the shaft camming surface and the stop;
providing a clamp apparatus on the shaft adjacent the shaft camming surface, the clamp apparatus comprising:
two interconnected clamp segments having respective recesses defining a receptacle for receiving the shaft;
clamp camming surfaces extending radially inwardly from at least a portion of each of the respective recesses for engaging the shaft camming surface; and
a closure adjustable to move the clamp segments toward each other around the shaft; and
driving the coaxial rotor assembly components into desired respective axial abutting positions along the shaft and against the first stop by adjusting the closure to produce a camming action between the clamp camming surfaces and the shaft camming surface that drives the clamp segments axially inward along the shaft.

15. The method of claim 14 in which the step of forming a shaft camming surface includes forming a circumferential groove in the shaft.

16. The method of claim 14 in which:
the step of providing a stop on the shaft includes forming a second shaft camming surface on the shaft and providing a second clamp apparatus on the shaft adjacent the second shaft camming surface, the second clamp apparatus comprising:
two interconnected clamp segments having respective recesses defining a receptacle for receiving the shaft;
clamp camming surfaces extending radially inwardly from at least a portion of each of the respective recesses for engaging the respective shaft camming surfaces; and
a closure adjustable to move the clamp segments toward each other around the shaft; and
the step of driving the coaxial rotor assembly components into desired respective axial abutting positions along the shaft includes adjusting the closures of the first and second clamp apparatti to produce camming actions between the clamps and the respective shaft camming surfaces that drives the clamp segments axially inward along the shaft.

17. The method of claim 14 in which the step of providing a plurality of coaxial rotor assembly components on the shaft includes providing rotor plates and corresponding spacers on the shaft.

18. The method of claim 14 in which:
the step of providing a clamp apparatus includes providing a closure in the form of fasteners disposed in through openings formed through the clamp segments; and
the step of driving the coaxial rotor assembly components includes tightening the fasteners.
